(19) United States
(12) Patent Application Publication
(10) Pub. No.: US 2003/0121590 A1
(43) Pub. Date: Jul. 3, 2003

(54) Process for producing a multi-directional textile preform, device for practicing it and preform thus obtained

(76) Inventors: Georges Cahuzac, Le Bouscat (FR); Fabien Barrot, Bordeaux (FR)

Correspondence Address: YOUNG & THOMPSON, 745 SOUTH 23RD STREET 2ND FLOOR, ARLINGTON, VA, 22202

(21) Appl. No.: 10/304,759

(22) Filed: Nov. 27, 2002

(30) Foreign Application Priority Data
Nov. 27, 2001 (FR) 01 15313

(51) Int. Cl. B32B 1/00

(52) U.S. Cl. 156/91; 156/148; 156/433; 428/107

(57) ABSTRACT

The object of the invention is a process for the production of a multi-directional textile preform, in which there is deposited on a substrate suitable for stitching (M) a first layer of sections of thread, then, if desired, one or several other layers in different directions, so as to produce a sequence of depositions, then, carrying out if desired one or several other sequences of deposition of layers, each section of thread (3₁, 3₂, 3₃) being, at each end, fixed by stitching without knotting into said substrate (M) with the help of a needle (11, 12), characterized in that the stitching at the two ends of each section (3₁, 3₂, 3₃) is carried out independently with the help of two needles (11, 12) using separate threads (P_{l , P}₂) from that of the layers, the end of the section of thread being, upon arrival of the deposition head at the height of its point of turning back, fixed by the stitching thread, the embedded stitching needle serving as a hooking pin for the thread during deposition of the following section, the needle remaining embedded at least until the stitching needle of the other end of said following section is embedded.

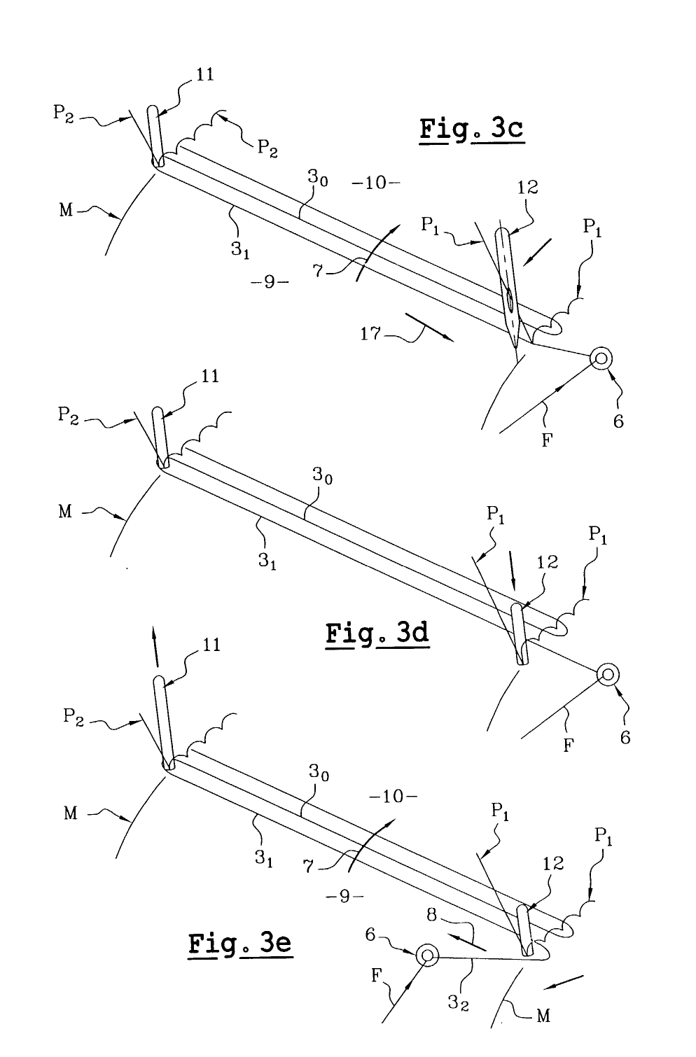

Use in the production of composite pieces FIG. 3e

The present invention relates to the production of textile preforms adapted for the production of pieces of composite material and more particularly for so-called dry preforms, or if desired specially prepared, that it is necessary later to densify by infiltrating the matrix into the preform, no matter what the nature of the matrix, ceramic, metallic or organic.

There can be generally distinguished two families of textile preforms:

those which are principally flat, the large majority of the threads being disposed in one plane. In this case, it is necessary to have several directions of placement of the threads in the plane, generally four directions;

those which have the threads distributed in the three directions in space and which are constituted by a superposition of planar structures of the type of the first family, connected transversely.

By thread is meant generally speaking an assembly of several thousands of natural or synthetic fibers, mineral or organic, for example of carbon, silica, silicon carbide, glass, Kevlar, etc . . . .

Generally speaking, to produce the preforms, it is necessary to operate at two stages:

first there are deposited one or more layers of threads in one plane

then the different layers are connected by placing threads in the third direction in space.

One of the ways of depositing the layers of threads in the plane is to use pins, between which are deposited the threads (sections of threads). These sections are locally oriented in the same direction. At the time of placement in the third direction, the pins are withdrawn.

This method is particularly interesting because it permits producing either finished products, which can be shaped, or semi-products.

Such a technique is for example shown by the patent FR 2 718 757 in the name of the applicant.

According to another manner of proceeding shown in the patent FR 2 718 758 also in the name of the applicant, the use of pins is avoided by stitching the thread at each end at the same time that it is deposited, the thread being deposited on a foam support in which the thread sections are fixed by stitching without knocking, with the help of a needle.

The drawback of this technology is that the stitching thread, which is located in the third dimension of the preform, is the same as that which is located in the two other dimensions.

The present invention seeks precisely to avoid this drawback by providing a new technology permitting having in no matter what direction a specific thread and hence optimized according to need.

To this end, the invention has for its object a process for the production of a multi-directional textile preform, in which there are deposited on a substrate suitable for stitching, a first layer of thread sections in a first direction, then, if desired, one or several other layers of sections of thread oriented in different directions, so as to produce a sequence of depositions, then, if desired to carry out one or several other sequences for the deposition of layers, identical or not to the first sequence, each layer of the thread being, at each end, fixed by stitching without knotting in said substrate with the help of a needle, characterized in that the stitching at the two ends of each section is carried out independently with the help of two needles using separate threads from those of the layers, the end of the thread section being, upon arrival of the deposition head at the height of its point of turning back, fixed by the stitching thread, the stitching needle sunk into the substrate serving provisionally as a fastening pin for the thread during deposition of the following section, said needle remaining sunk in said substrate at least until the embedding of the stitching needle of the other end of said following section.

Such a process permits using for the blocking of the ends of each thread section, threads of a different nature than that of the threads of the layers, the blocking threads at the two ends being if desired different so as to be optimized as a function of the envisaged uses.

According to another important advantage of the process, each thread section deposited can be perfectly held and placed if desired in slight tension by being stretched between the two needles sunk in the substrate.

It is to be noted that the process of the invention permits mechanically optimizing the preforms by permitting the placement of the thread sections at emplacements selected so as to obtain finally evolved thicknesses and/or profiles of composite pieces.

The invention also has for its object a device for practicing the above process, comprising a substrate suitable for stitching, with shapes and sizes of the preform to be produced and means for depositing the threads of the layers constituting said pre-form, characterized in that it moreover comprises a set of two stitching needles for said transverse layers with each its own thread supply device, means to position the two needles facing stitching positions on the substrate, and means to synchronize the embedding and retraction movements of the needles on the one hand between them, on the other hand with the trajectory of said means for depositing the threads and, finally, with relative movement between the substrate and said needles.

The invention also has for its object the three-dimensional textile preforms obtained by the process defined above.

It is to be noted in this connection that the substrate suitable for stitching, which is generally a foam material for example a polyurethane foam, can preferably be constituted by an existing textile preform of a shape and size that can be as desired and adapted to be integrated to the preform produced according to the process of the invention by superposition on the substrate-preform, fastening together the two preforms being ensured by said stitching.

There can also be produced complex composite pieces of a variable thickness and of any desired profile.

Other characteristics and advantages of the invention will become apparent from the description which follows, of an embodiment of said process, which description is given by way only of example, and with respect to the accompanying drawings, in which:

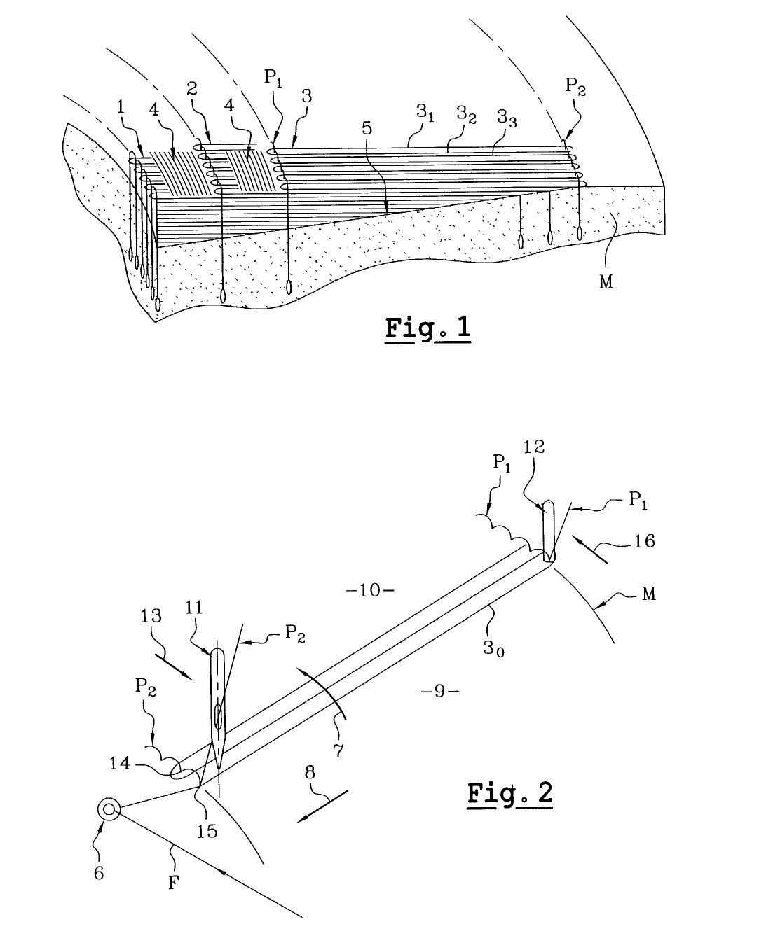

FIG. 1 is a fragmentary cross-sectional schematic view of a multi-dimensional textile preform produced according to the process of the invention;

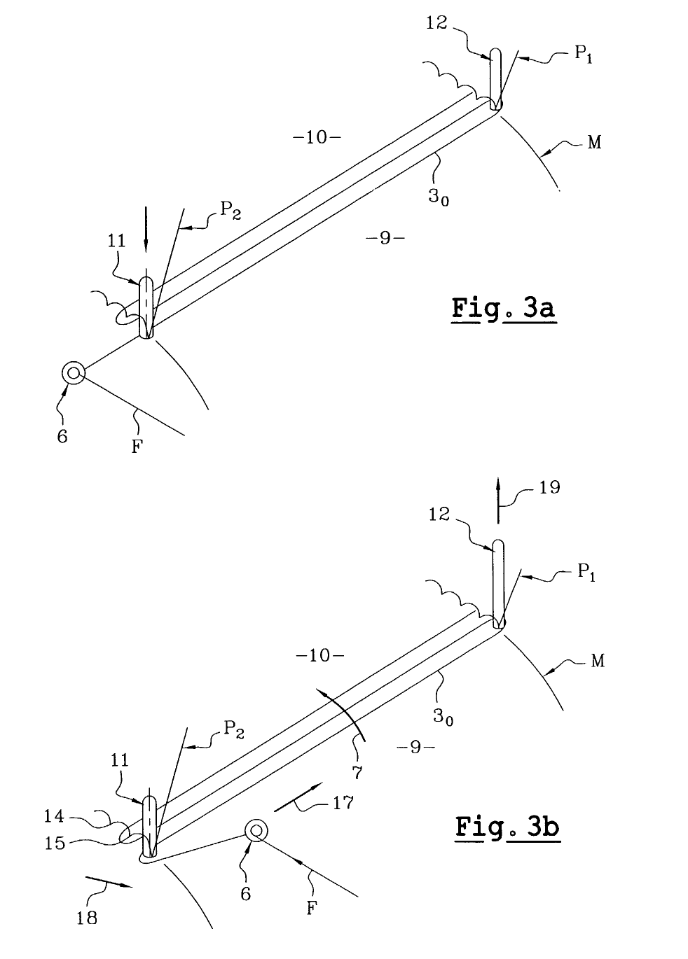

FIG. 2 shows the weaving cycle of the preform of FIG. 1;

FIGS. 3a to 3e show different sequences of the weaving cycle;

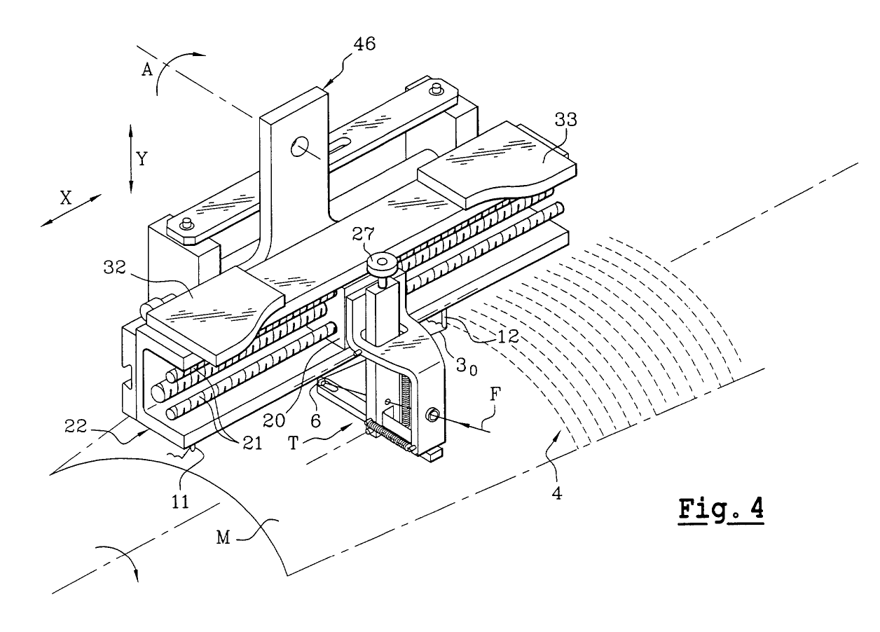

FIG. 4 is a fragmentary perspective schematic view of a device for practicing the process;

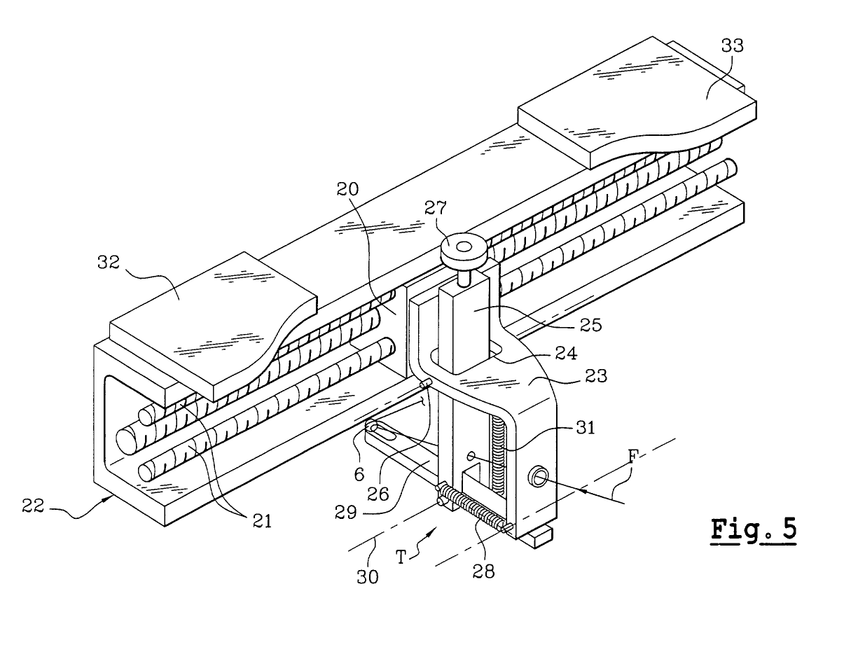

FIG. 5 is a view only of the weaving mechanism of the device of FIG. 4, and

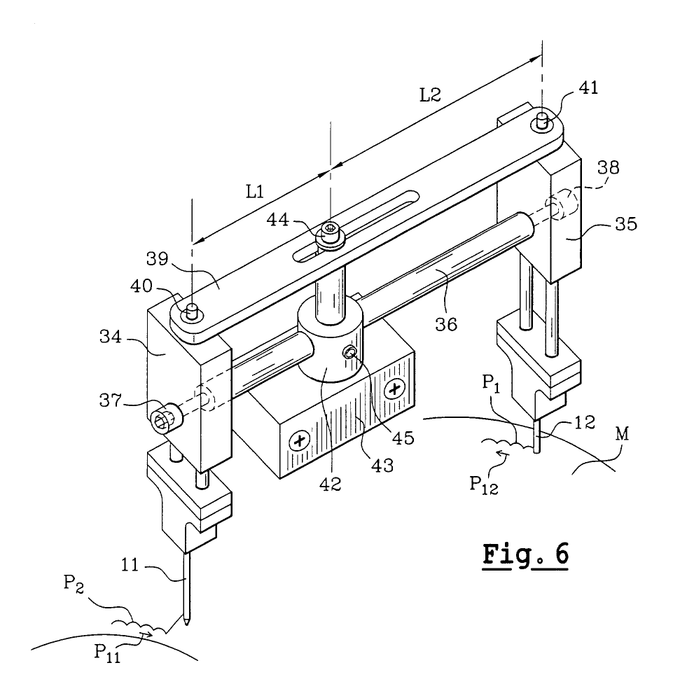

FIG. 6 is a view only of the stitching mechanism of said device.

FIG. 1 shows an example of embodiment of a preform according to the process of the invention, said preform being constituted by a structure of truncated conical shape formed by layers, 1, 2, 3 of sections of parallel thread, superposed whilst being slightly axially offset in the manner of roof tiles.

Between two layers is disposed a layer 4 of threads disposed by winding orthogonally to the sections of thread of the layers 1, 2, 3.

Such a structure is described in greater detail for example in the document FR 2 718 758, cited above.

At M in FIG. 1 is shown a mandrel whose periphery is constituted, in a known manner, by a sufficiently rigid but flexible material, such as a foam of synthetic material, particularly a polyurethane foam.

The surface 5 of the mandrel M is truncated conical and receives successive depositions of layers, only three layers (1, 2, 3) of so-called longitudinal threads being shown in FIG. 1.

Each layer 1, 2, 3 is constituted by the deposit, substantially parallel because the surface 5 is truncated conical, of sections, for example 31, 32, 33, etc . . . , of a same thread F called a weaving thread, emplaced in a conventional manner with the help of a weaving head of which there is shown in FIGS. 2 and the following, for purposes of clarity, only the weaving eyelet 6.

The eyelet 6 of the weaving head is, as will be seen in greater detail later on with reference to FIGS. 4 and 5, carried by a movable carriage reciprocable in the vertical axial plane of the mandrel M, above this latter.

The thread sections 31, 32, 33, etc . . . have a length for example of several tens of centimeters, the weaving thread F forming axial zigzags stopped at each end by a thread forming a circumferential stitching point.

Thus, and according to the invention, behind the deposited layer (3) the ends of the sections 31, 32, 33, etc . . . are stopped by a stitching thread P₁, separate from the weaving thread F, however in front of said layer 3 the ends of said sections are stopped by a second stitching thread P₂ also separate from thread F. The directions rear and front of the stitching threads P₁, P₂ are determined according to the direction (from left to right in FIG. 1) of superposed deposition of the layers (1, 2, 3, etc . . .).

Such a method of stitching the opposite edges of the layers has important advantages.

It is thus that the stitching threads, P₁ and P₂, which are identical or not, can be optimized in consideration of their function. For example, the front stitching thread P₂ which only has the role of holding the foot of the weaving thread F and which will be finally eliminated by internal machining of the preform, could be constituted by a more poorly performing material which is less costly.

On the contrary, the front stitching thread P₁, which is on the external exposed surface of the preform, will be selected in the framework of a compromise between its various functions and the existing regulations.

More precisely, this thread P₁ must on the one hand hold the weaving thread F of the layers.

Then, as to heat, it must not create in its mass of the piece of final composite material transverse holes during heating of the surface of the piece, nor create notable transverse thermal conductivity. Moreover, the thread P₁ must have a good mechanical strength against shock and must also render the composite material reliable by avoiding delamination of the tiles formed by the layers, which can appear at the end of polymerization because of the decrease of volume of the resin already hardened. The choice of the thread P₁ thus will take account of these various requirements.

The process of the invention also permits a gain in quality over the spreading of each layer relative to a blockage of the layers by stitching the weaving thread at each end of the section of deposited thread, because the weaving thread F being no longer platted at its two ends, it is not obliged to pass through the small round hole of a stitching needle.

A gain of quality of also obtained by the fibrous architecture of the preform because the transverse stitching thread P₁, P₂ will be selected with a smaller cross-section, of about a third for example, as that of the weaving thread F, so as to decrease the size of the slots created by the passage of the threads.

Again in comparison with the technology of stitching the ends of the sections of weaving thread, the process of the invention leads to separating the three functions: weaving and two independent stitchings. Each function can thus be mechanically optimized and the sequences constituting a weaving cycle can be rendered parallel as will be seen later when describing such a cycle with reference to FIGS. 2 et seq.

Finally, the process permits a gain in reliability because the weaving thread no longer need be stitched and hence no longer risks breaking during this operation. The stitching needles can use threads of the sewing type, twisted and solid, and be constituted by standard sewing needles, hence with excellent quality at a low price.

FIG. 2 shows a weaving cycle or, more precisely, the different movements of the members or elements that move during the production of a deposition of consecutive sections of the weaving thread F.

In FIG. 2, the mandrel M is seen, contrary to FIG. 1, with its reduced diameter portion to the left, where the stitching of the front thread P₂ takes place.

The rotation of the mandrel M takes place in the direction of the arrow 7, in incremental manner, each increment corresponding to the interval between two consecutive sections.

Arrow 8 indicates the direction of movement of the weaving head, symbolized by the weaving eyelet 6, for laying down the last section shown in FIG. 2.

Reference 9 designates the upstream portion of the mandrel M which is to be covered by the parallel sections each contained in an axial plane of the mandrel, and reference 10 designates the downstream portion.

At 11 is shown the front stitching needle and at 12 the rear stitching needle. The mechanism of actuating these needles will be described in greater detail with reference to FIGS. 4 and 6.

Arrow 13 indicates the movement in translation of the needle 11 by an interval corresponding to the interval between two front stitches, respectively 14 and 15, whilst the arrow 16 indicates the same movement but in the reverse direction of the rear needle 12.

FIG. 2 shows the start of a cycle of laying down two sections of weaving thread F, the section which has been emplaced being designated by reference 30.

At this initial stage, the eyelet 6 which is moved in the direction of the arrow 8 is beyond the front stitching line P₂ and the front needle 11 is in the upper position after forming the last stitching 15, whilst the rear needle 12 is in the position sunk into the material of the mandrel M and bypassed by the leaving thread.

The first sequence (FIG. 3a) consists in sinking the front needle 11 into the mandrel M.

The following sequence (FIG. 3b) consists in moving the carriage for the weaving head (eyelet 16) toward the rear of the mandrel in the direction of arrow 17, after slight movement (arrow 18) of said head orthogonally to the axis of the mandrel M. The movement of the carriage for the weaving head controls the rising (arrow 19) of the rear needle 12, then the rotation (arrow 7) of the mandrel.

This rotation drives downstream (arrow 16) the front embedded needle 11, which controls a relative movement toward the upstream 9 of the rear needle 12 relative to the mandrel.

At the end of the sequence 2 (FIG. 3c) is emplaced the section 31, achieved when the eyelet 6 is located beyond the rear stitching line P₁ after having passed below the rear needle 12.

At this time, (sequence 3, FIG. 3d), the needle 12 plunges into the mandrel M so as to trap the thread F with the help of thread P₁.

It is to be noted that during the path of deposition of the section 31 the thread F is perfectly held by the sunk in needle 11 which it has bypassed, which permits imparting to said thread F a deposition under slight tension.

The thread F is also stretched, at the outset of deposition of said section, by the front needle 12 which it does not raise.

It is to be noted that this deposition of the thread sections F can take place in contact with the help of a suitable head.

During this sequence 3, the rear needle 12 and the front needle 11 are both embedded in the mandrel M.

At sequence 4 (FIG. 3e), the weaving eyelet 6 again starts forwardly (needle 11) after bypassing the rear needle 12 by the thread F for the deposition of the following section 32. The movement of the eyelet 6 controls the rising of the front needle 11 and the rotation (arrow 7) by one increment of the mandrel M. This rotation causes a downstream movement 10 of the embedded rear needle 12, which controls the relative movement upstream 9 of the front needle 11 in the upper position.

At the end of the trajectory of the eyelet, the parts are in the position shown in FIG. 2.

The various sequences described above can be simultaneous in whole or in part.

It is to be noted most particularly that in the course of laying down the sections of thread F the needles 11 and 12 in the embedded position serve as pins for hooking the weft thread and thus contribute to precise positioning and ultimately tensioned, of said sections of thread constituting the layer.

The cycle thus described repeats until all the truncated region of the mandrel in question has been covered by the layer. Then, a layer of circumferential threads as shown at 4 in FIG. 1 is wound, and a new tile is produced by weaving a new layer such as 3 with a certain axial offset of the mandrel M.

Referring now to FIGS. 4 to 6, there will be described an embodiment of the means adapted to practice the process.

The device shown in FIG. 4 comprises two side by side associated mechanisms, namely a weaving mechanism shown alone in FIG. 5 and a stitching mechanism shown alone in FIG. 6.

In FIG. 4, there is shown symbolically at M the mandrel, at 4 a layer of circumferential threads, at F the weaving thread of which a section 3₀ is in the course of deposition along a generatrix of the mandrel M, thanks to a weaving head T carried by a carriage 20 adapted to slide along two slideways 21 of a conventional jack 22 without a piston rod. The carriage 20 is driven by the piston of the jack 22 by a mechanical connection through the wall of the jack whose two closed ends are not, for purposes of, clarity, shown in FIGS. 4 and 5.

To the carriage 20 is fixed (FIG. 5) a piece 23 in the form of a Z provided with a window 24 traversed by a vertical support 25 articulated on the piece 23 about an axis 26 parallel to the slideways 21.

The upper end of the support 25 carries a roller 27 with an axis perpendicular to the axis 26, except that the lower end is secured to a spring 28 also anchored at the lower end of the support 25 and holding this latter against the upper portion of the piece 23.

A blade 29 is mounted on the lower forked end of the support 25 and is articulated about an axis 30 parallel to the axis 26.

The front of the blade 29 carries the weaving eyelet 6, whilst at the rear, said blade is held against the piece 23 by a spring 31 of low stiffness.

At the two ends of the jack 22 are fixed two cams 32 and 33.

When the carriage 20 slides toward one end, the roller 27 bears against the corresponding cam (for example 32) and causes the piece 25 to pivot, which then moves the blade 29 and hence moves laterally the eyelet 6 so as to place the thread F below the needle 11 which is located in the upper position (FIG. 4).

During the return, the reverse movement takes place and permits eyelet 6 not to hook the needle 11 or the support of this latter.

The spring 31 permits the eyelet 6 to brush the surface on which it moves to deposit the thread, without risk of damaging this surface.

The stitching mechanism (FIG. 6) is constituted by two pneumatic jacks with a double rod 34 and 35, carrying the respective needles 11 and 12. Each jack is connected to a rod 36 by two axles 37, 38 permitting freedom in rotation.

The upper portions of the jacks 34, 35 are connected by a blade 39 by means of two resilient connections 40 and 41.

The rod 36 is fixed adjustably on a pivot support 42 itself fixed by means of roller bearings on a plate 43. The blade 39 is fixed to the upper portion of the support 42 by a ring 44 with a certain play to permit the blade to turn and slide relative to the support 42.

Such a mechanism forms a resiliently deformable structure and permits two crossing rotations: the first about the axis of the pivot 42 and the second perpendicular to the first about axes 37, 38. It is to be noted that the position of the pivot 42 relative to the two jacks 34, 35 can be easily modified by releasing the securement screw 45 of said pivot 42.

The two mechanisms of FIGS. 5 and 6 are joined (FIG. 4) so as to cause to correspond the position of the eyelet 6 relative to the ends of the needles 11 and 12 as shown in FIGS. 2 and 3a to 3e.

These two mechanisms are fixed on a common support 46 orientable as to angle relative to the surface for deposition of the threads.

A computer machine control with four axes ensures: the rotation R of the mandrel M, the translation along X parallel to the axis of the mandrel, the radial translation perpendicular to the axis of the mandrel, as well as an axis A of rotation perpendicular to the plane XY to produce in particular round pieces.

The computer control of this machine connects the contacts actuated by movements of the jacks 22, 34 and 35 and controls the electro-valves supplying these jacks.

When the jack 35 descends, it sinks the needle 12 into the mandrel M. This action controls the movement of the carriage 20 toward the needle 11. The movement of the carriage 20 controls the rising of the needle 11 and the rotation of the mandrel M.

The rotation of this mandrel is of small amplitude and drives the needle 12 over a short distance called an increment and symbolized in FIG. 6 by the small vector P₁₂.

The movement by the increment P₁₂ of the needle 12 gives rise, because of the articulated mechanism of FIG. 6, to a movement in the reverse direction of the needle 11, in the upper position, by a distance or increment P₁₁. The increments P₁₁, P₁₂ are connected by the relationship P₁₁/P₁₂ =L₁/L₂ =D₁/D₂ in which: L₁ and L₂ are the distances of each needle 11, 12 from the pivot 42 and D₁ and D₂ are the respective diameters of stitching in the case of the production of a conical or cylindrical preform.

It is to be noted that in the course of movement by step P₁₂ of the needle 12, this latter will also be subjected to a small rotation about the axis 38, which will be returned to the jack 34 via the blade 39 which pivots about the ring 44.

At the end of these two rotations, the needle 11 is thus in place such that the thread P₂ covers the thread F as soon as the carriage 20 and the cam 27 arrive at the height of cam 32.

The needle 11 will then sink, this sequence corresponding to the schematic diagram of FIG. 3a and being followed, as shown in FIG. 3b, by the movement along arrow 18 of the weaving head consecutive to the movement (arrow 17) of this head causing the roller 27 to leave the cam 32.

The process of the invention is of course applicable to the production of all types of three-dimensional preforms, whether flat or not, and it suffices that the substrate suitable for stitching and on which the various layers are produced, be of suitable shape.

In the preceding description, the substrate in question is constituted by a flexible material forming part of the mandrel. It is also possible to constitute such a substrate in the form of an existing textile preform, of a shape and dimensions that can be variable and on which will be produced according to the process of the invention a second textile preform with which the first preform will be integrated to give a final composite piece with a geometry that can be as desired.

In the course of the production of the second preform, the first preform will serve as a flexible substrate permitting a stitching according to said process so as to ensure both the securement of the layers of the second preform together and the securement together of the two superposed preforms.

The preform of the invention can be constituted by a stack of superposed layers without offset between layers and of any orientation of the sections of the different layers.

There can also be superposed several layers with different orientations of the sections of weaving thread, this superposition being repeated if desired with the same design of orientation or not.

It should also be noted that the process of the invention permits optimizing mechanically the preforms and permits the placement of the sections of threads in positions selected so as to obtain the desired thicknesses and/or profiles of the final composite pieces.

Moreover, the stitching threads P₁, P₂ are dry threads or pre-impregnated threads.

1. Process for the production of a multi-directional textile preform, in which there is deposited on a substrate suitable for stitching (M) a first layer of sections of thread in a first direction, then, if desired, one or several other layers of sections of thread oriented in different directions, so as to produce a deposition sequence, then if desired carrying out one or several other sequences of deposition of layers, identical or not to the first sequence, each section of thread (31, 32, 33) being, at each end, fixed by stitching without knotting in said substrate (M) with the help of a needle (11, 12), characterized in that the stitching at the two ends of each section (31, 32, 33) carried out independently with the help of needles (11, 12) using separate threads (P₁, P₂) from that of the layers (1, 2, 3), the end of the section of thread being, upon arrival of the deposition head at the height of its point of turning back, fixed by the stitching thread, the stitching needle in the position embedded in the substrate serving provisionally as a hooking pin for the thread during deposition of the following section, said needle remaining embedded in said substrate at least until the stitching needle of the other end of said following section becomes embedded.

2. Process according to claim 1, characterized in that there is used as a stitching thread (P₁, P₂) threads of different characteristics and properties.

3. Process according to claim 1 or 2, characterized in that the deposition of said sections (31, 32, 33) is carried out by contact and/or under light tension.

4. Process according to one of claims 1 to 3, characterized in that the substrate suitable for stitching is a material constituted by a foam of synthetic material.

5. Process according to one of claims 1 to 3, characterized in that said substrate suitable for stitching is a previously produced textile preform.

6. Device for practicing the process according to one of claims 1 to 5, comprising a substrate suitable for stitching (M) in the form and dimensions of the preform to be produced and means (6) for depositing threads (F) of the layers (1, 2, 3) constituting said preform, characterized in that it moreover comprises a set of two needles (11, 12) for stitching said layers (1, 2, 3) transversely with each having its device for supplying thread (P₁, P₂), means to position the two needles facing the positions of stitching on the substrate (M), and means to synchronize the movements of sinking into and withdrawal of the needles (11, 12) on the one hand between them, on the other hand with the trajectory of said means (6) for depositing threads (F) and, finally, with the relative movement between the substrate (M) and said needles (11, 12).

7. Device according to claim 6, characterized in that said means for depositing threads (F) are constituted by a weaving head (T) provided with a weaving eyelet (6) and mounted on a carriage (20) movable along slideways (21) under the action of a jack (22) and means (23 to 33) for, at the end of the path of said carriage (20) at each end of said slideways (21), provisionally laterally displacing said weaving eyelet (6).

8. Device according to claim 6, characterized in that said set of two needles (11, 12) is mounted at the end of jacks (34, 35) interconnected by a resiliently deformable structure (36, 44) and permitting a rotation of the needles (11, 12) simultaneously and in reverse directions about a common axis (37, 38) perpendicular to that of said needles, as well as a simultaneous rotation of the needles about an axis (42) parallel to that of said needles.

9. Three-dimensional textile preform obtained according to the process of any one of claims 1 to 5.
